(19) United States
(12) Patent Application Publication
(10) Pub. No.: US 2026/0131335 A1
(43) Pub. Date: May 14, 2026

(54) SYSTEM FOR REMOVING MATERIAL UNSUITABLE FOR SHREDDING, DRUM-TYPE MAGNETIC SEPARATOR, INFORMATION PROCESSING DEVICE, METHOD OF SEPARATING MATERIAL UNSUITABLE FOR SHREDDING, CONTROL METHOD OF INFORMATION PROCESSING DEVICE, AND PROGRAM

(71) Applicant: NIPPON STEEL CORPORATION, Tokyo (JP)

(72) Inventors: Keizo KAWAMURA, Tokyo (JP); Kenji IKEDA, Tokyo (JP); Koji HIRANO, Tokyo (JP); Nobuyuki TATEMIZO, Tokyo (JP)

(73) Assignee: NIPPON STEEL CORPORATION, Tokyo (JP)

(21) Appl. No.: 19/118,305

(22) PCT Filed: Nov. 22, 2023
(86) PCT No.: PCT/JP2023/042011

§ 371 Date: Apr. 3, 2025

(30) Foreign Application Priority Data
Nov. 22, 2022 (JP) 2022-186360

(51) Int. Cl. B03C 1/12; B02C 23/08; G06V 20/52; G06V 20/64

(52) U.S. Cl. CPC B03C 1/12; B02C 23/08; B03C 2201/20; G06V 20/52; G06V 20/64; G06V 2201/06

(57) ABSTRACT

A system for removing material unsuitable for shredding that removes, before feeding scrap into a shredding facility that shreds the scrap, materials unsuitable for shredding that may cause damage to the shredding facility, the system includes: a drum-type magnetic separator that removes magnetic materials having a weight equal to or greater than a predetermined weight from the scrap; an imaging device that photographs scrap in which the magnetic materials having a weight equal to or greater than a predetermined weight have been removed by the drum-type magnetic separator; and an information processing device that acquires a photographed image from the imaging device and analyzes it, the information processing device uses a learning model identifying material unsuitable for shredding to identify material unsuitable for shredding, based on a photographed image, and when the material unsuitable for shredding is identified, outputs information indicating that scrap includes material unsuitable for shredding.

### TECHNICAL FIELD

The present invention relates to a technique suitable for use in removing in advance scrap that may damage a shredding facility. This application is based upon and claims the benefit of priority of the prior Japanese Patent Application No. 2022-186360, filed on Nov. 22, 2022, the entire contents of which are incorporated herein by reference.

### BACKGROUND ART

In recent years, there has been an increasing need to reduce CO₂ emissions in order to curb global warming, and in the steel industry, the electric furnace method has been attracting attention as an alternative to the blast furnace method that emits CO₂ gas. In the electric furnace method, scrap iron, which is discarded vehicles, discarded home electrical appliances, buildings, and other used iron products, is mainly used as a main raw material. On the other hand, various metals and non-metals other than iron are used in discarded vehicles, discarded home electrical appliances, buildings, and other used iron products, and when scrap (to be referred to as waste scrap below) generated from waste material such as used iron products is shredded in a shredding facility, sorting the scrap into iron, other metals, and non-metals is commonly performed.

Here, in the case of feeding the waste scrap into a shredding facility, if materials unsuitable for shredding, which are a pressure vessel such as a gas cylinder involving a risk of explosion or another hazard and a large iron block such as a motor or shape steel, in particular, are fed thereinto, there is a risk that they may damage the shredding facility, and thus, it is necessary to remove these materials in advance before feeding them into the shredding facility.

Conventionally, when removing such materials unsuitable for shredding as described above before feeding them into a shredding facility, a worker operated heavy equipment to visually sort and remove the materials. However, the removing operation by a worker required sorting from a huge amount of waste scrap, resulting in that removal efficiency was low due to oversights, incorrect sorting, or another reason, and explosions or troubles frequently occurred inside the shredding facility. Therefore, various techniques have been proposed to remove materials unsuitable for shredding.

Patent Literature 1 has disclosed a method of providing, at the inlet side of a shredder, a discharge part for detecting an unsuitable material, which is not suitable for shredding, using a monitoring camera and then making it fall and discharging it to the outside of a shredding system. Further, Patent Literature 2 has disclosed a method of automatically detecting a material unsuitable for shredding using X-ray fluoroscopic images, automatically stopping a refuse feeder, and removing the material using an unsuitable material removing device.

However, the method described in Patent Literature 1 is a technique in which a monitoring worker visually inspects video of the monitoring camera, and if a material unsuitable for shredding is included in the video, he/she removes and discharges the material unsuitable for shredding to the outside of the shredding system, and therefore, there is still a possibility of oversights, incorrect sorting, or the like. Further, the method described in Patent Literature 2 is a system in which a material is simply determined to be a material unsuitable for shredding when pixels with a density equal to or greater than a predetermined value consecutively occupy a predetermined area or more in the X-ray fluoroscopic images, and therefore, the detection accuracy is insufficient and there is still a possibility of oversights, incorrect sorting, or the like.

### CITATION LIST

### Patent Literature

Patent Literature 1: Japanese Laid-open Patent Publication No. 2011-92902

Patent Literature 2: Japanese Laid-open Patent Publication No. 08-309227

Patent Literature 3: Japanese Laid-open Patent Publication No. 2005-144390

### Non-Patent Literature

Non-Patent Literature 1: Joseph Redmon, and 3 others, “You Only Look Once: Unified, Real-Time Object Detection” [retrieved May 18, 2021], Internet <https://arxiv.org/abs/1506.02640>

Non-Patent Literature 2: Olaf Ronneberger, and 2 others, “U-Net: Convolutional Networks for Biomedical Image Segmentation” [retrieved May 18, 2021], Internet <URL: https://arxiv.org/abs/1505.04597>

Non-Patent Literature 3: Samet Akcay, and 2 others, “GANomaly: Semi-Supervised Anomaly Detection via Adversarial Training” [retrieved May 18, 2021], Internet <https://arxiv.org/abs/1805.06725>

Non-Patent Literature 4: Paul Bergmann, and 3 others, “Improving Unsupervised Defect Segmentation by. Applying Structural Similarity to Autoencoders,” [retrieved May 18, 2021], Internet <https://arxiv.org/abs/1807.02011>

Non-Patent Literature 5: Paolo Napoletano, and 2 others, “Anomaly Detection in Nanofibrous Materials by CNN-Based Self-Similarity,” [retrieved May 18, 2021], Internet <https://www.ncbi.nlm.nih.gov/pmc/articles/PMC5795842/>

### SUMMARY OF INVENTION

### Technical Problem

In consideration of the previously-described problems, the present invention has an object to make it possible to accurately remove, before feeding waste scrap into a shredding facility, materials unsuitable for shredding that may damage the shredding facility from an individual piece of waste scrap.

### Solution to Problem

The system for removing material unsuitable for shredding according to the present invention is a system for removing material unsuitable for shredding that removes, before feeding scrap into a shredding facility that shreds the scrap, materials unsuitable for shredding that may cause damage to the shredding facility, the system including: a drum-type magnetic separator whose magnetic force is set so as to attract a magnetic material having a weight less than a predetermined weight from the scrap; and an information processing device including: an identification means configured to identify a magnetic material that is to be the material unsuitable for shredding, based on at least one of a photographed image and a measurement result of a three-dimensional shape of a magnetic material having been attracted to and separated by the drum-type magnetic separator; and an output means configured to output, when a material unsuitable for shredding is identified by the identification means, information indicating that the material unsuitable for shredding is included.

The drum-type magnetic separator according to the present invention is a drum-type magnetic separator that configures a system for removing material unsuitable for shredding that removes, before feeding scrap into a shredding facility that shreds the scrap, materials unsuitable for shredding that may cause damage to the shredding facility, in which a magnetic force is set so as to attract a magnetic material having a weight less than a predetermined weight from the scrap.

The information processing device according to the present invention is an information processing device that acquires at least one of a photographed image and a measurement result of a three-dimensional shape of a magnetic material in a system for removing material unsuitable for shredding that removes, before feeding scrap into a shredding facility that shreds the scrap, materials unsuitable for shredding that may cause damage to the shredding facility, the information processing device including: an identification means configured to identify a magnetic material that is to be the material unsuitable for shredding, based on at least one of a photographed image and a measurement result of a three-dimensional shape of the magnetic material; and an output means configured to output, when a material unsuitable for shredding is identified by the identification means, information indicating that the material unsuitable for shredding is included.

The method of separating material unsuitable for shredding according to the present invention is a method of separating material unsuitable for shredding in a system for removing material unsuitable for shredding that removes, before feeding scrap into a shredding facility that shreds the scrap, materials unsuitable for shredding that may cause damage to the shredding facility, the method including: a first step of attracting and separating a magnetic material having a weight less than a predetermined weight from the scrap at a drum-type magnetic separator; and a second step of identifying a magnetic material that is to be the material unsuitable for shredding, based on at least one of a photographed image and a measurement result of a three-dimensional shape of a magnetic material having been attracted to and separated by the drum-type magnetic separator, thereby removing the material unsuitable for shredding.

Further, another characteristic of the method of separating material unsuitable for shredding according to the present invention is a method of separating material unsuitable for shredding by using a drum-type magnetic separator that configures a system for removing material unsuitable for shredding that removes, before feeding scrap into a shredding facility that shreds the scrap, materials unsuitable for shredding that may cause damage to the shredding facility, the method including: attracting and separating a magnetic material having a weight less than a predetermined weight from the scrap.

The control method of the information processing device according to the present invention is a control method of an information processing device that acquires at least one of a photographed image and a measurement result of a three-dimensional shape of a magnetic material in a system for removing material unsuitable for shredding that removes, before feeding scrap into a shredding facility that shreds the scrap, materials unsuitable for shredding that may cause damage to the shredding facility, the method including: an identification step of identifying a magnetic material that is to be the material unsuitable for shredding, based on at least one of a photographed image and a measurement result of a three-dimensional shape of the magnetic material; and an output step of outputting, when a material unsuitable for shredding is identified at the identification step, information indicating that the material unsuitable for shredding is included.

The program according to the present invention is a program for controlling an information processing device that acquires at least one of a photographed image and a measurement result of a three-dimensional shape of a magnetic material in a system for removing material unsuitable for shredding that removes, before feeding scrap into a shredding facility that shreds the scrap, materials unsuitable for shredding that may cause damage to the shredding facility, the program making a computer execute: an identification step of identifying a magnetic material that is to be the material unsuitable for shredding, based on at least one of a photographed image and a measurement result of a three-dimensional shape of the magnetic material; and an output step of outputting, when a material unsuitable for shredding is identified at the identification step, information indicating that the material unsuitable for shredding is included.

### Advantageous Effects of Invention

According to the present invention, before feeding waste scrap into a shredding facility, materials unsuitable for shredding that may damage the shredding facility can be accurately removed from an individual piece of waste scrap.

### BRIEF DESCRIPTION OF DRAWINGS

FIG. 1 is a view for explaining an outline of a system for removing material unsuitable for shredding intended for removing materials unsuitable for shredding in an embodiment of the present invention.

FIG. 2 is a block diagram illustrating a functional configuration example of an information processing device that detects a material unsuitable for shredding in the embodiment of the present invention.

FIG. 3 is a block diagram illustrating a hardware configuration example of the information processing device that detects a material unsuitable for shredding in the embodiment of the present invention.

FIG. 4 is a flowchart illustrating an example of a processing procedure that detects a material unsuitable for shredding using a learning model by an information processing p device in a first embodiment of the present invention.

FIG. 5 is a view for explaining an outline of a drum-type magnetic separator that discharges materials unsuitable for shredding to the outside of the system in the first embodiment of the present invention.

FIG. 6A is a view illustrating an example of an image photographed by a monitoring camera and a training image that clearly illustrates a material unsuitable for shredding.

FIG. 6B is a view illustrating another example of the image photographed by the monitoring camera and the training image that clearly illustrates the material unsuitable for shredding.

FIG. 6C is a view illustrating another example of the image photographed by the monitoring camera and the training image that clearly illustrates the material unsuitable for shredding.

FIG. 7A is a view illustrating an example of a display screen when a material unsuitable for shredding is detected.

FIG. 7B is a view illustrating another example of the display screen when the material unsuitable for shredding is detected.

FIG. 8 is a view for explaining an outline of a drum-type magnetic separator in an overfeed mode that discharges materials unsuitable for shredding to the outside of the system in a second embodiment of the present invention.

FIG. 9 is a view for explaining an outline of removing materials unsuitable for shredding that have been conveyed onto a second vibrating feeder in a third embodiment of the present invention.

FIG. 10A is a view illustrating a specific example of basic shape data.

FIG. 10B is a view illustrating a specific example of an image in which edges extracted from a two-dimensional image are illustrated.

FIG. 10C is a view illustrating a specific example of an image in which surfaces extracted from the two-dimensional image are illustrated.

FIG. 11A is a view illustrating a specific example of point cloud data.

FIG. 11B is a view illustrating specific example of edges extracted from the point cloud data.

FIG. 11C is a view illustrating a specific example of surfaces extracted from the point cloud data.

FIG. 12A is a view for explaining a method of identifying a surface that should be focused on in a shape such as a half-cut steel pipe.

FIG. 12B is a view for explaining another method of identifying the surface that should be focused on in the shape such as a half-cut steel pipe.

### DESCRIPTION OF EMBODIMENTS

The following embodiments of the present invention will be explained with reference to the drawings. In the following explanation, materials unsuitable for shredding are those that may damage a shredding facility, which indicate pressure vessels such as gas cylinders involving a risk of explosion or another hazard and large iron blocks such as motors and shape steel, for example.

### First Embodiment

### System Configuration

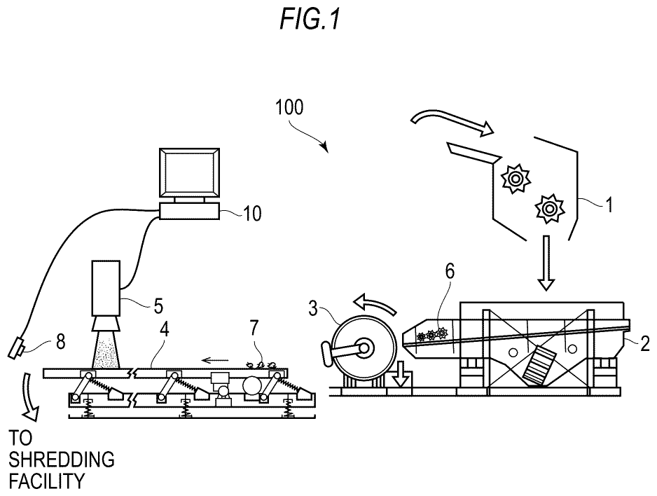

FIG. 1 is a view for explaining an outline of a system 100 for removing material unsuitable for shredding intended for removing materials unsuitable for shredding in this embodiment,

As illustrated in FIG. 1, in the system 100 for removing material unsuitable for shredding according to this embodiment, first, a worker uses heavy equipment to feed waste scrap into a pre-shredder 1, where it is coarsely shredded. Then, the coarsely shredded waste scrap is conveyed onto a first vibrating feeder 2. The coarsely shredded waste scrap may include materials unsuitable for shredding, but at least some of the materials unsuitable for shredding are discharged to the outside of the system by a drum-type magnetic separator 3. Meanwhile, the waste scrap collected by the drum-type magnetic separator 3 is conveyed onto a second vibrating feeder 4 and is photographed by a monitoring camera 5 provided in the middle of the second vibrating feeder 4. If a material unsuitable for shredding that was not discharged by the drum-type magnetic separator 3 is detected based on an image of the monitoring camera 5, the material unsuitable for shredding is removed using a robot arm (not illustrated) or the like. Each facility is explained in detail below.

The pre-shredder 1 has two shaft or three shaft rotors, and the bladed rotors rotate at a low speed, to thereby coarsely shred the waste scrap that has been fed into the pre-shredder 1 in a state having been compressed into a pressed shape, or in another state. The pre-shredder 1 can process, when the waste scrap is fed into the pre-shredder 1, the waste scrap into shapes that can be shredded. Incidentally, the pre-shredder 1 is a coarse shredding facility, and thus has a larger clearance between the rotors compared to a normal shredder, and has a structure in which materials unsuitable for shredding slip through between the rotors easily. Further, scrap larger than the clearance between the rotors fails to be coarsely shredded, causing the rotors to stop due to overload tripping. The coarsely shredded waste scrap is dropped onto the first vibrating feeder 2.

The first vibrating feeder 2 is a vibrating feeder for supplying waste scrap to the drum-type magnetic separator 3, and conveys waste scrap 6 having been piled up when having been placed on a conveyor while spreading it over the entire conveyor by vibration, thereby improving the accuracy of magnetic separation by the drum-type magnetic separator 3.

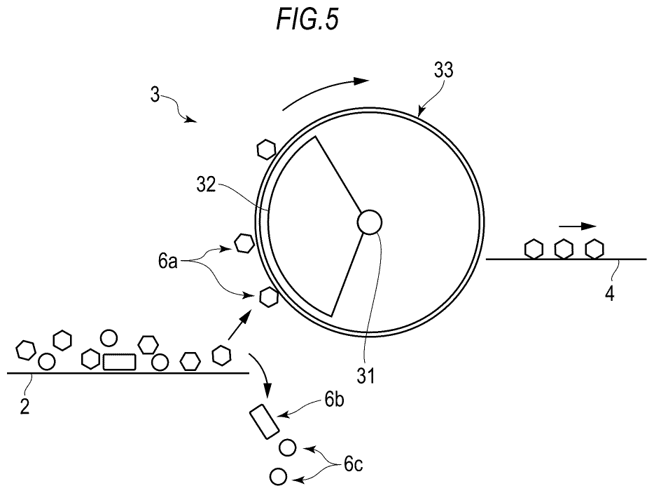

The drum-type magnetic separator 3 has a magnet mounted inside a drum, and collects iron attracted to the magnet as the outer side of the drum rotates. The details of the drum-type magnetic separator 3 are explained here with reference to FIG. 5.

As illustrated in FIG. 5, the drum-type magnetic separator 3 rotates a rotating drum 33 with an electromagnet 32 mounted therein around a drum shaft 31, thereby attracting materials 6a (magnetic materials) for shredding such as thin and lightweight materials to the rotating drum 33 from the waste scrap 6 and collecting them. Meanwhile, non-magnetic materials 6c (nonferrous metals, plastics, rubber, dust, and so on) that fail to be attracted by the magnetic force of the electromagnet 32 are discharged to the outside of the system. Further, the waste scrap 6 to be conveyed by the first vibrating feeder 2 is the one coarsely shredded, and thus unlike an ordinary magnetic separator, materials unsuitable for shredding 6b, such as thick and heavyweight materials, are also conveyed towards the drum-type magnetic separator 3. This embodiment is designed so that at least one of the distance between the tip of the first vibrating feeder 2 and the drum-type magnetic separator 3, the magnetic force of the electromagnet 32, and the rotation speed of the rotating drum 33 is adjusted as appropriate, thereby making it possible to separate the materials 6a for shredding from the materials unsuitable for shredding 6b and discharge the materials unsuitable for shredding 6b.

Incidentally, the electromagnet 32 does not rotate. Further, the material 6a for shredding attracted to the rotating drum 33 by the electromagnet 32 moves with the rotation of the rotating drum 33, and moves forward by inertial force after it leaves the region of the magnetic force of the electromagnet 32. Thereafter, the material 6a for shredding falls by gravity onto the second vibrating feeder 4 and thereby is separated from the drum-type magnetic separator 3. However, this is not limited to this embodiment, and the material 6a for shredding that has left the electromagnet 32 may be collected, conveyed to the second vibrating feeder 4 by hand or by a carrier or the like, and placed on the second vibrating feeder 4. Further, a plurality of plate-shaped members extending radially from the surface of the rotating drum 33 may be provided along the circumferential direction, making it possible to support magnetic materials that slide during rotation and forcibly convey them in the direction of rotation even at the point where they are out of the region of the magnetic force of the electromagnet 32. Further, a specific shape of the electromagnet 32 and its position in the rotating drum 33 are arbitrary, as long as the electromagnet 32 can attract and separate the material 6a for shredding as described above.

When the distance between the tip of the first vibrating feeder 2 and the drum-type magnetic separator 3 is increased, the effect of the magnetic force can be reduced accordingly, and when the rotation speed of the rotating drum 33 is increased, the conveying amount can be increased. Further, when the magnetic force of the electromagnet 32 is increased too much, even the material unsuitable for shredding, such as a thick or heavyweight material, is attracted to the rotating drum 33, and thus the magnetic force of the electromagnet 32 is adjusted according to the weight and size that may. damage the shredding facility. In this manner, by adjusting the distance between the tip of the first vibrating feeder 2 and the drum-type magnetic separator 3, the rotation speed of the rotating drum 33, and the magnetic force of the electromagnet 32, a material unsuitable for shredding having a weight equal to or greater than a predetermined weight is no longer collected by the magnetic force, and therefore the material unsuitable for shredding having a weight equal to or greater than a predetermined weight, such as a thick or heavyweight material, can be discharged to the outside of the system. Incidentally, when adjusting the rotation speed of the rotating drum 33, it is preferable to adjust also the conveying speed of the first vibrating feeder 2. Meanwhile, hollow objects such as gas cylinders and waste scrap that contains light metals such as Al other than iron have a small weight relative to their volume, and thus they may be collected as material for shredding despite their large volume. The waste scrap collected by the drum-type magnetic separator 3 falls onto the second vibrating feeder 4. In this manner, in this embodiment, the magnetic material having a weight equal to or greater than a predetermined weight is supposed to have difficulty in being attracted to the rotating drum 33 by the magnetic force of the electromagnet 32, and the magnetic material having a weight less than a predetermined weight is supposed to be easily attracted to the rotating drum 33 by the magnetic force of the electromagnet 32.

More specifically, the magnetic force of the drum-type magnetic separator 3 may be set so as to attract a magnetic material having a weight less than a predetermined weight while taking into account the distance from the drum-type magnetic separator 3 and the rotation speed of the rotating drum 33, for example. The magnetic force may be adjusted by adjusting the value of current flowing through the electromagnet, for example. A magnetic material having a weight less than a predetermined weight may be attracted to the electromagnet 32 of the drum-type magnetic separator 3, by adjusting at least one of the distance from the drum-type magnetic separator 3 and the rotation speed of the rotating drum 33 after determining the magnetic force of the drum-type magnetic separator 3. In the case where the magnetic force of the drum-type magnetic separator 3 is fixed, a permanent magnet may be used as the magnet. Incidentally, in terms of this point, the same is true of a later-described drum-type magnetic separator 80 in an overfeed mode.

Similarly to the first vibrating feeder 2, the second vibrating feeder 4 conveys waste scrap 7 having been piled up while spreading it over the entire conveyor by vibration. Incidentally, in a certain region in the middle of the second vibrating feeder 4, the waste scrap being conveyed is photographed from above by the monitoring camera 5. At this time, when vibrations are generated by the second vibrating feeder 4 in the region in which the monitoring camera 5 photographs, a photographed image is blurred. Therefore, it is preferable to spread the piled-up waste scrap 7 over the entire conveyor before the waste scrap 7 reaches the region in which the monitoring camera 5 photographs and not to generate vibrations by the second vibrating feeder 4 in the region in which the monitoring camera 5 photographs. From this viewpoint, another general belt conveyor that does not vibrate may be provided downstream of the second vibrating feeder 4, and the waste scrap 7 on that belt conveyor may be photographed by the monitoring camera 5.

The monitoring camera 5 photographs waste scrap being conveyed directly below or diagonally from above, and sequentially transfers a photographed image to an information processing device 10 in real time. The information processing device 10 detects a material unsuitable for shredding from the photographed image, and notifies a monitoring worker when a material unsuitable for shredding is detected. Incidentally, the method of detecting material unsuitable for shredding will be explained later. Further, in order to supplement height information of the waste scrap within a photographing range of the monitoring camera 5, shape measurement of the waste scrap is also performed in parallel by a three-dimensional shape measuring device 8. The result of the shape measurement is also transferred to the information processing device 10 to be used for determination of whether or not there is material unsuitable for shredding. As the three-dimensional shape measuring device 8, for example, a device such as a ToF (Time of Flight) camera or a laser scanner is used.

Incidentally, in the example illustrated in FIG. 1, there is one monitoring camera 5, but in order to further improve the detection accuracy of material unsuitable for shredding, a plurality of cameras may be arranged along the width direction or conveyance direction. Further, there is sometimes a case where height information is predictable to some extent, as in the case of a gas cylinder, and thus the shape measurement by the three-dimensional shape measuring device 8 may be omitted in order to simplify the system 100 for removing material unsuitable for shredding.

When the materials unsuitable for shredding are removed from the second vibrating feeder 4, the materials for shredding are collected and conveyed to a not-illustrated shredding facility. The shredding facility is a well-known facility (see, for example, Patent Literature 1), and on the shredding facility side, the materials for shredding are further shredded by a shredder, and then separated into magnetic materials such as iron and metals other than the magnetic material by a magnetic separator.

### Configuration of the Information Processing Device

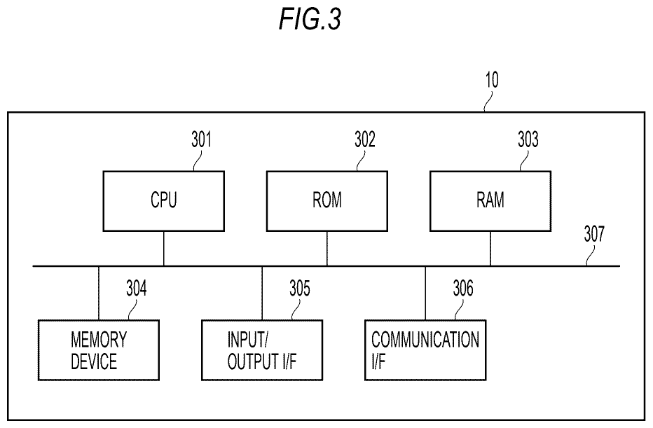

Then, a detailed procedure for detecting a material unsuitable for shredding using the monitoring camera 5 is explained. FIG. 3 is a block diagram illustrating a hardware configuration example of the information processing device 10 that detects material unsuitable for shredding in this embodiment.

As illustrated in FIG. 3, the information processing device 10 includes a CPU 301, a ROM 302, a RAM 303, a memory device 304, an input/output I/F 305, and a communication I/F 306, which are connected by a bus 307.

The CPU 301 reads control programs stored in the ROM 302 or the memory device 304 and executes various pieces of processing. The RAM 303 is used as a temporary storage area such as a main memory or work area of the CPU 301. The memory device 304 stores various data, various programs, and so on. The input/output I/F 305 is an interface for accepting various operations by a user via a keyboard or mouse and displaying arithmetic calculation results on a not-illustrated display device.

The communication I/F 306 is an interface for acquiring information from an external device via a network, or the like. The photographed image of waste scrap photographed by the monitoring camera 5 is received by the information processing device 10 in this embodiment via the communication I/F 306 by wired or radio communication. Further, the measurement result of the three-dimensional shape measuring device 8 is also received by the information processing device 10 in this embodiment via the communication I/F 306 by wired or radio communication.

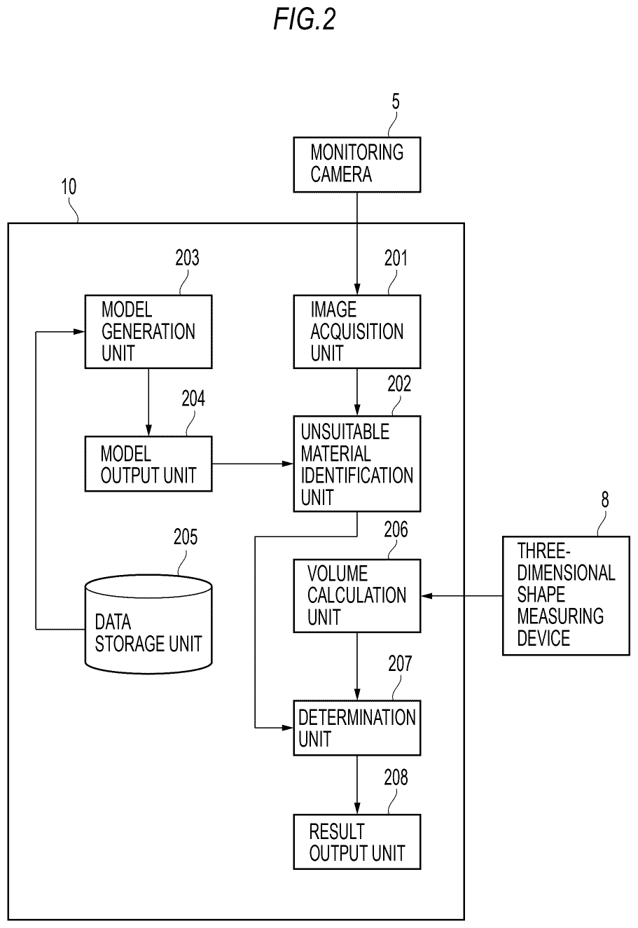

FIG. 2 is a block diagram illustrating a functional configuration example of the information processing device 10 according to this embodiment. Incidentally, each of the components illustrated in FIG. 2 is implemented by the CPU 301 reading and executing a control program stored in the ROM 302 or the memory device 304. Each of the components is explained below.

An image acquisition unit 201 acquires photographed images photographed by the monitoring camera 5 as video or one or more still images. The photographed image acquired here is an image obtained by photographing the waste scrap being conveyed by the second vibrating feeder 4 as described above, and the angle of view of the monitoring camera 5 is set to match the length along the width direction of the second vibrating feeder 4. Therefore, the monitoring camera 5 can photograph so that the waste scrap is included in the entire photographed image.

An unsuitable material identification unit 202 inputs the photographed image acquired in the image acquisition unit 201 into a learning model (a learning model that has already been trained by machine learning) and identifies a candidate for material unsuitable for shredding and its position within the photographed image. Here, the learning model is a model that has been trained to identify a material unsuitable for shredding from images, and its details will be explained later. Incidentally, the materials unsuitable for shredding include not only magnetic materials corresponding to thin and lightweight materials (for example, gas cylinders with big cavity), but also thick or heavyweight materials that failed to be separated by the drum-type magnetic separator 3.

A volume calculation unit 206 receives the measurement result from the three-dimensional shape measuring device 8, and calculates the volume of an individual piece of waste scrap, based on the measurement result. Incidentally, since this embodiment aims to identify a material unsuitable for shredding, calculating the volume of waste scrap, which does not clearly belong to the material unsuitable for shredding based on the measurement result of a three-dimensional shape, may be omitted. For example, only the volume of the waste scrap whose height direction is equal to or greater than a predetermined value or whose surface area is equal to or greater than a predetermined value may be calculated. Further, measuring a three-dimensional shape is intended to supplement the information on the height direction of the candidate for material unsuitable for shredding having been identified by the learning model, and thus only the height direction of an individual piece of waste scrap may be calculated without calculating the volume. Compared to the case of calculating also the volume, when only the height is calculated, the accuracy of identifying whether or not a material is material unsuitable for shredding may decrease, but the time required to identify whether or not a material is material unsuitable for shredding can be shortened because the amount of arithmetic calculation decreases.

A determination unit 207 determines whether or not the candidate for material unsuitable for shredding is actually the material unsuitable for shredding, based on the candidate for material unsuitable for shredding identified in the unsuitable material identification unit 202 and the volume of the waste scrap calculated in the volume calculation unit 206. Incidentally, there may be cases where a waste scrap is not identified as the candidate for material unsuitable for shredding by the learning model when viewed vertically, but the waste scrap has a height equal to or greater than a predetermined value and has a volume corresponding to a material unsuitable for shredding. However, the waste scrap is conveyed so that the pile of the waste scrap is flattened by vibration of the second vibrating feeder 4. Therefore, it may be believed that such a case does not occur.

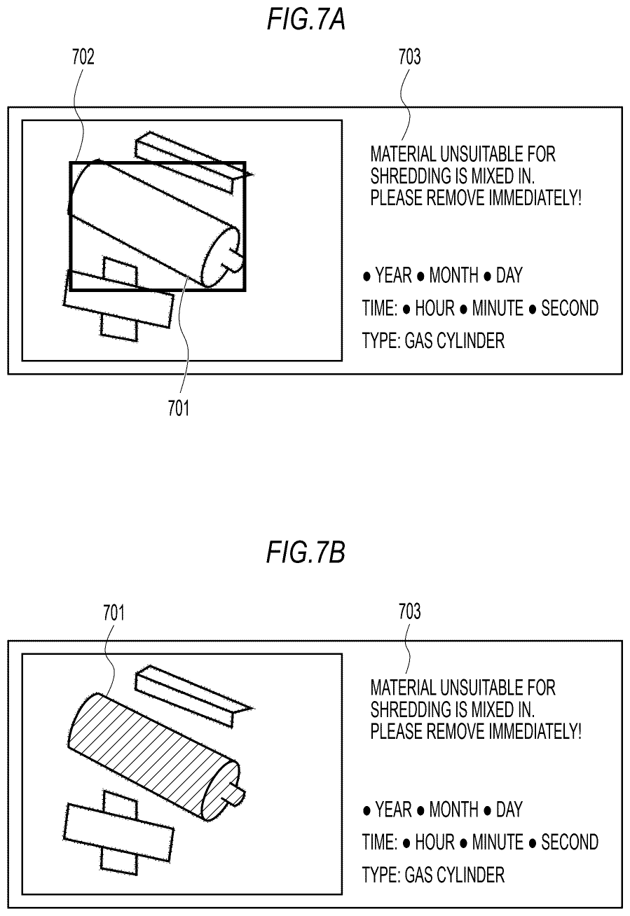

When the determination unit 207 determines that a material unsuitable for shredding is included, a result output unit 208 notifies that fact. The notification method is not particularly limited, but any method may be used as long as the worker can visually identify the material unsuitable for shredding and remove the material unsuitable for shredding. For example, as in an image illustrated in FIG. 7A, an image in which a region of a material unsuitable for shredding 701 is surrounded by a rectangle 702 in a photographed image may be displayed on a not-illustrated display device, and warning content 703 may also be displayed therewith. Further, as in an image illustrated in FIG. 7B, a superimposed image in which the material unsuitable for shredding 701 is marked may be generated, and the superimposed image and the warning content 703 may be displayed on the not-illustrated display device. Further, as another method, the position of the material unsuitable for shredding or the like may be notified from a not-illustrated audio speaker. In this way, the worker that operates the previously-described robot arm or the like can identify the position of the material unsuitable for shredding and remove the material unsuitable for shredding. Incidentally, this robot arm or the like does not need to be operated by the worker and may be operated automatically. In this case, a determination result that a material unsuitable for shredding is included and information relating to the position of its presence or the like may be output directly to the robot arm the like.

Then, the details of the learning model are explained. The learning model is a trained model generated by deep learning (deep learning) such as a neutral network, for example. As a deep learning method, a multi-layer neural network such as a Convolutional Neural Network (CNN) can be applied, but the deep learning method is not limited to this.

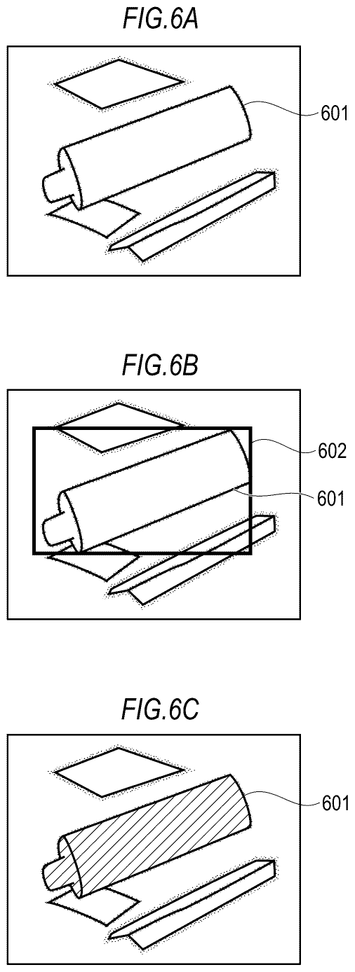

A model generation unit 203 generates a single or plural learning models that identify the position of a material unsuitable for shredding from a photographed image photographed by the monitoring camera 5 and the probability of being material unsuitable for shredding. Specifically, the model generation unit 203 uses, as training data, a plurality of data in which such a photographed image including waste scrap as illustrated in FIG. 6A is associated with information indicating the type and position of a material unsuitable for shredding 601 (a gas cylinder in the case of FIG. 6A to FIG. 6C) included in the image, and generates a model that identifies a type and a position of a material unsuitable for shredding in an image and the probability of being material unsuitable for shredding by machine learning. For example, the model generation unit 203 generates such a learning model as described in Non-Patent Literatures 1 and 2, which outputs a type and a position of an object in an image and the probability of being the object. Incidentally, the type of material unsuitable for shredding may be output in such a way that types of materials unsuitable for shredding are classified into a plurality of types, such as “gas cylinder” and “shape steel,” or one type of “material unsuitable for shredding,” simply be output.

The training data are stored in a data storage unit 205 in advance, and in this embodiment, images photographed in the past by the monitoring camera 5 and label data that can represent a correct region in which a material unsuitable for shredding is present in the images are used as a set of training data. For example, a region where a material unsuitable for shredding is present is manually determined in advance in images photographed in the past, and the images where the entire materials unsuitable for shredding are labeled (marked) are used as a set of training data.

The images which were photographed and used as the training data are desirably images photographed by the same camera as the photographed images used to detect a material unsuitable for shredding in the unsuitable material identification unit 202, but they may also be images photographed by a different camera. Further, as the images used for the training data, the images obtained by photographing an actual material unsuitable for shredding that is blended in waste scrap are desirable, but they may be images of a material unsuitable for shredding that can be acquired from the Internet or the like (such as an image of a gas cylinder). During training, an objective function for optimization is set and trained so that the probability of being material unsuitable for shredding is equal to or greater than a predetermined reference value (for example, 100%) with respect to the manually created correct label data.

Incidentally, the label data used here may be marked image data in which the position of the material unsuitable for shredding 601 in the photographed images is marked, as illustrated in FIG. 6C. At this time, as information indicating the type of the marked material unsuitable for shredding, a brightness value assigned in advance to each of materials unsuitable for shredding can be used. For example, when gray scale images represented by brightness values ranging from 0 to 255 grades are used as a marking image, a gas cylinder is marked with a brightness value of 100, a shape steel is marked with a brightness value of 50, or the like, and thereby the types of materials unsuitable for shredding can be distinguished by the brightness values of respective pixels. Of course, the coordinates of a plurality of pixels having brightness values assigned to each material unsuitable for shredding may be used as the information representing the position of the marked material unsuitable for shredding.

Further, as illustrated in FIG. 6B, the label data may be text data including rectangle information 602 or the like created to surround the material unsuitable for shredding in the photographed images. For example, for the text data, coordinate data of a rectangle may be used as the position of the material unsuitable for shredding, and information capable of distinguishing the material unsuitable for shredding within the rectangle may be used as the type of the material unsuitable for shredding. For the data of the photographed images used above, for example, formats such as jpg, bmp, and png are used, and for the text data, formats such as txt, json, and xml are used.

Meanwhile, the model generation unit 203 may generate a learning model that trains normal images and detects a deviation from the normal as anomaly, as in Non-Patent Literatures 3 to 5. In this method, a plurality of images of normal waste scrap that does not include materials unsuitable for shredding are used to make the learning model train the features required to represent normal waste scrap When an image including a material unsuitable for shredding is input into the trained model generated by training normal waste scrap in this manner, an abnormal portion and the degree of abnormality are output as anomaly. When this model is employed, a value based on the degree of abnormality is used for the probability of being material unsuitable for shredding, which is output to an operator. For example, the value of the degree of abnormality is normalized to fall within a range of 0.0 to 1.0, and this degree of abnormality is regarded as the probability of being material unsuitable for shredding. By the learning model using this method, whether there is anomaly, namely, whether there is material unsuitable for shredding, is output, but the output does not go so far as to the type such as “gas cylinder” or “shape steel”.

The learning model is not limited to the one described above. For example, it may be a two-class classification model that classifies the photographed images into two classes of normal images in which material unsuitable for shredding are not seen and abnormal images in which material unsuitable for shredding are seen. Alternatively, the learning model may be a multi-class classification model that classifies the photographed images by the type of material unsuitable for shredding. The multi-class classification model differs from the learning model in accordance with Non-Patent Literatures 1 and 2 described above in that its output does not go so far as to the information on position of a material unsuitable for shredding in the photographed images.

The above explanation has been made on the assumption that one photographed image at a certain point in time is input into the learning model, but a plurality of sequentially photographed images may be input. For example, an algorithm that takes into account also a time-series property of photographed images, such as a recurrent neural network (RNN), may be used. For example, by adding determination results in the past or the like to the current input, the determination accuracy with respect to the current photographed image to be determined can be improved.

The model generation unit 203 starts process to generate a trained model based on an instruction from a user in advance before executing removal of material unsuitable for shredding as a pre-process of feeding waste scrap into the shredding facility using the system 100 for removing material unsuitable for shredding. Alternatively, the model generation unit 203 may execute the process to generate a trained model periodically.

The training conditions of the learning model in this embodiment include model conditions, dataset conditions, and training setting conditions. The model conditions are conditions related to the structure of the neural network. The dataset conditions include selecting conditions of training data to be input to the neural network during training, conditions of preprocessing of these data and an image augmentation method, and so on. The training setting conditions include initialization conditions of neural network parameters such as weights and biases, optimization method conditions, loss function conditions, and so on. Here, the loss function conditions also include conditions of the regularization function.

When starting process to generate a trained model, the model generation unit 203 first acquires from the data storage unit 205 training data necessary for generating a learning model capable of detecting a material unsuitable for shredding included in the waste scrap from a photographed image photographed by the monitoring camera 5. Then, the model generation unit 203 uses the acquired training data to generate the learning model capable of detecting a material unsuitable for shredding by machine learning.

When training the features of a material unsuitable for shredding in images and generating a learning model that calculates the type and the position of the material unsuitable for shredding and the probability of being material unsuitable for shredding during detection, the model generation unit 203 inputs the photographed images including a material unsuitable for shredding acquired from the data storage unit 205 into the learning model, and optimizes the learning model so that the position (region) of the material unsuitable for shredding output from the learning model approaches the correct position where the material unsuitable for shredding is present and so that the type of the material unsuitable for shredding and the probability of being the material unsuitable for shredding are equal to or greater than a predetermined reference value (for example, 100%). When the learning model in this format is used for the detection of material unsuitable for shredding, the type of the material unsuitable for shredding, the coordinate data representing the position (region) of the material unsuitable for shredding, and the value of probability representing the degree of certainty are Output from the learning model (see, Non-Patent Literature 1, for example).

On the other hand, when training the features of the entire normal waste scrap by using the photographed images of normal waste scrap that does not include a material unsuitable for shredding as training data, considering only the case where a material unsuitable for shredding is included in the waste scrap as anomaly during detection, and generating a learning model that calculates the abnormal position and the degree of abnormality, the model generation unit 203 inputs the photographed images of normal waste scrap that does not include a material unsuitable for shredding, acquired from the data storage unit 205, into the learning model, and trains the features of the entire normal waste scrap. At this time, the model generation unit 203 optimizes the learning model so that the generated learning model can represent (output) that material unsuitable for shredding is not included in the waste scrap. In this case, for the calculation of the position of the material unsuitable for shredding and the probability of being material unsuitable for shredding when photographed images including a material unsuitable for shredding are input into the learning model, difference images or degrees of abnormality between the photographed images input into the learning model and the photographed images output from the learning model are used (see, for example, Non-Patent Literature 3).

After generating the learning model by machine learning, the model generation unit 203 outputs the learning model to a model output unit 204.

The model output unit 204 outputs the learning model generated by the model generation unit 203. For example, the model output unit 204 outputs the learning model generated by the model generation unit 203 to the unsuitable material identification unit 202 so that the learning model can be used when the unsuitable material identification unit 202 identifies the type and the position of the material unsuitable for shredding and the probability of being material unsuitable for shredding.

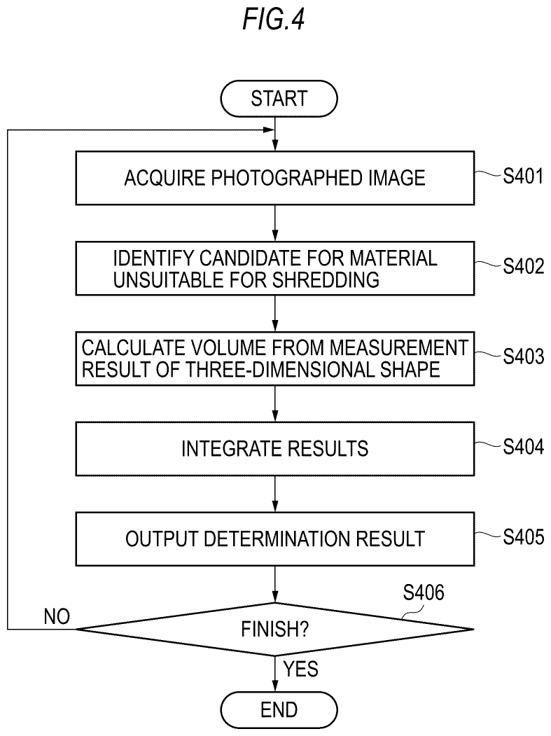

Next, the processing procedure for detecting the material unsuitable for shredding is explained by using the learning model generated by the above-described procedure. FIG. 4 is a flowchart illustrating an example of the processing procedure for detecting the material unsuitable for shredding by using the learning model by the information processing device 10 in this embodiment. Pieces of the processing related to FIG. 4 are executed by the CPU 301 reading a control program stored in the ROM 302.

First, at Step S401, the image acquisition unit 201 acquires a photographed image from the monitoring camera 5 in real time. Incidentally, the acquired image may be video or a still image. Further, when a plurality of the monitoring cameras 5 are installed, the image acquisition unit 201 acquires photographed images from these monitoring cameras 5 in real time.

Then, at Step S402, the unsuitable material identification unit 202 inputs the photographed image acquired in the image acquisition unit 201 into the learning model generated in the above-described process to generate a trained model by the model generation unit 203, and identifies the type and the position of the material unsuitable for shredding and the probability of being material unsuitable for shredding respectively. Then, the unsuitable material identification unit 202 identifies the material as a candidate for material unsuitable for shredding when the probability of being material unsuitable for shredding is equal to or greater than a predetermined value.

Then, at Step S403, the volume calculation unit 206 receives the measurement result of a three-dimensional shape from the three-dimensional shape measuring device 8, and calculates the volume or height of an individual piece of waste scrap from the measurement result. At this time, the volume calculation unit 206 receives information on the position and time at which the three-dimensional shape was measured therewith, to make the time at which the measurement was performed consistent with the time at which the photographed image was photographed. Incidentally, the processing at Step S403 may be performed before Step S401 or S402.

Then, at Step S 404, the determination unit 207 acquires information on the volume or height calculated in the volume calculation unit 206 for the candidate for material unsuitable for shredding identified at Step S402. Then, the determination unit 207 takes into account the length, width, and height of the candidate for material unsuitable for shredding, and determines whether or not the candidate for material unsuitable for shredding identified at Step S402 is the material unsuitable for shredding that should be removed.

Then, at Step S405, the result output unit 208 outputs information according to the determination result at Step S404. For example, when the candidate for material unsuitable for shredding is determined to be the material unsuitable for shredding that should be removed at Step S404 and information is output to the not-illustrated display device, the result output unit 208 generates a display screen including an image in which the material unsuitable for shredding 701 is surrounded by the rectangle 702 in the photographed image acquired in the image acquisition unit 201, as illustrated in FIG. 7A, or a display screen including an image in which the position of the material unsuitable for shredding 701 is marked, as illustrated in FIG. 7B, and displays the generated display image on the display device, thereby notifying the worker. At this time, in the case where the type of the material unsuitable for shredding can also be identified, information on the type of the material unsuitable for shredding is also displayed, thereby enabling the worker to more easily find and remove the material unsuitable for shredding when removing it.

On the other hand, when the candidate for material unsuitable for shredding is determined to be the material unsuitable for shredding that should be removed at Step S404 and in the case where audio data are output to a not-illustrated speaker, the result output unit 208 generates audio data to notify the worker of the type and the position of the material unsuitable for shredding and outputs them to the speaker. Further, when the candidate for material unsuitable for shredding is determined not to be the material unsuitable for shredding that should be removed at Step S404, the result output unit 208 does not need to output anything, and may instead display the photographed image acquired in the image acquisition unit 201 as it is on the display device.

At Step S406, the image acquisition unit 201 determines whether or not to finish the processing of detecting material unsuitable for shredding. This determination is performed, for example, based on whether or not the worker has operated a keyboard or the like to input an instruction to finish the detection of material unsuitable for shredding. When continuing the processing as a result of this determination, the operation returns to Step S401 and continues the processing of detecting material unsuitable for shredding successively. On the other hand, when finishing the processing, the processing in FIG. 4 is finished accordingly.

As described above, according to this embodiment, as the first stage, heavy waste scrap is discharged by the drum-type magnetic separator 3, so that it is possible to prevent waste scrap, such as iron blocks that have few cavities and are heavyweight, from being fed into the shredding facility. On the other hand, gas cylinders with large cavity and alloys with low specific gravity may not be discharged by the drum-type magnetic separator 3, but they can then be identified using the learning model from the images photographed by the monitoring camera 5, and thus, it is possible to more reliably prevent such waste scrap from being fed into the shredding facility.

Conventionally, magnetic material and non-magnetic material have been separated, such as in the drum-type magnetic separator as described in Patent Literature 3, but the drum-type magnetic separator 3 in this embodiment differs from the conventional one in that it separates heavyweight waste scrap and lightweight waste scrap among magnetic materials. Incidentally, in this embodiment, the example of generating a learning model in the information processing device 10 has been explained, but this embodiment may be configured to omit the training function, store a learning model generated in another external device, and perform only inference using the learning model.

### Second Embodiment

In the first embodiment, there has been explained the example where the drum-type magnetic separator 3 is used to discharge not only non-magnetic materials that cannot be attracted by the magnetic force of an electromagnet, but also materials unsuitable for shredding of thick and heavyweight magnetic materials to the outside of the system. The drum-type magnetic separator illustrated in FIG. 5 is a drum-type magnetic separator in a pick up mode, and in order to successfully drop and discharge the huge material unsuitable for shredding 6b such as a thick and heavyweight material to the outside of the system, it is necessary to increase the clearance, which is the distance between the tip of the first vibrating feeder 2 and the rotating drum 33. On the other hand, if the clearance is made too large, the material 6a for shredding such as a thin and lightweight material can no longer be attracted to the rotating drum 33.

Thus, in the system 100 for removing material unsuitable for shredding illustrated in FIG. 1, a drum-type magnetic separator in an overfeed mode may be used in place of the drum-type magnetic separator in a pick up mode illustrated in FIG. 5. In this embodiment, only the points that differ from the first embodiment are explained below.

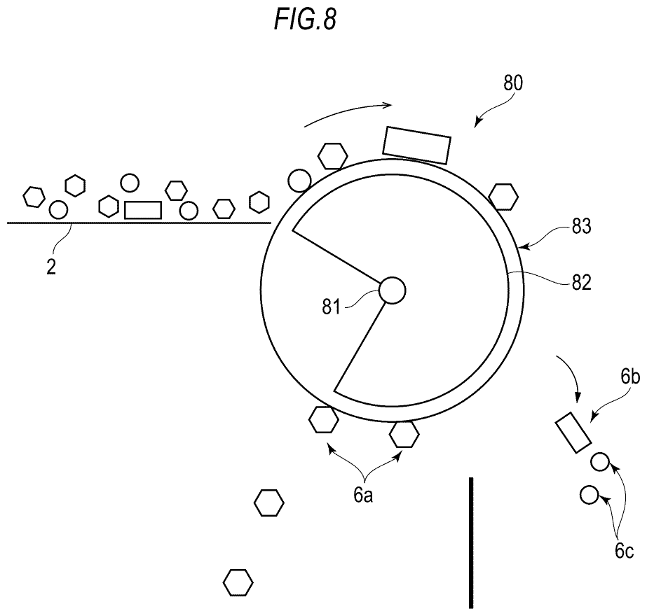

FIG. 8 is a view for explaining an outline of the drum-type magnetic separator in an overfeed mode that discharges materials unsuitable for shredding to the outside of the system. As illustrated in FIG. 8, the drum-type magnetic separator 80 is the same as the drum-type magnetic separator in a pick up mode illustrated in FIG. 5 in that it rotates a rotating drum 83 with an electromagnet 82 mounted therein around a drum shaft 81 to thereby attract the materials 6a for shredding such as thin and lightweight materials from the waste scrap 6 to the rotating drum 83 and collect them. However, in this embodiment, the materials 6a for shredding such as thin and lightweight materials, the huge materials unsuitable for shredding 6b such as thick and heavyweight materials, and the non-magnetic materials 6c that have been conveyed by the first vibrating feeder 2 are temporarily placed on the rotating drum 83. Then, by utilizing the fact that the point of fall changes depending on the balance between magnetic force and gravity, the materials 6a for shredding are separated from the materials unsuitable for shredding 6b and the non-magnetic materials 6c. Incidentally, as with the example illustrated in FIG. 5, the electromagnet 82 does not rotate. Further, as long as the electromagnet 82 can separate the materials 6a for shredding from the materials unsuitable for shredding 6b and the non-magnetic materials 6c as described above, a specific shape of the electromagnet 82 and its position in the rotating drum 33 are arbitrary. The material 6a for shredding attracted to the rotating drum 83 by the electromagnet 32 moves as the rotating drum 83 rotates, and remains attracted until the region of the magnetic force of the electromagnet 82. Then, when leaving the region of the magnetic force of the electromagnet 82, the material 6a for shredding falls by gravity to be separated from the drum-type magnetic separator 80. On the other hand, among the materials unsuitable for shredding 6b, a thick and heavyweight material having a weight equal to or greater than a predetermined weight cannot maintain its attracted state until it leaves the region of the magnetic force of the electromagnet 82 as the rotating drum 83 rotates, and falls along the way, when the balance between magnetic force and gravity is lost.

In the case of the non-magnetic materials 6c, they are not attracted to the rotating drum 83 by the electromagnet 82, and thus, the non-magnetic material 6c placed on the rotating drum 83 falls directly down by gravity as the rotating drum 83 rotates. Further, the huge material unsuitable for shredding 6b is magnetic material and is attracted to the rotating drum 83 by the magnetic force of the electromagnet 82, but as the rotating drum 83 rotates, the gravitational force to detach the material unsuitable for shredding 6b from the rotating drum 83 becomes larger, resulting in that the material unsuitable for shredding 6b falls accordingly. Incidentally, in this embodiment, all the conveyance materials including the materials 6a for shredding such as thin and lightweight materials, the materials unsuitable for shredding 6b, and the non-magnetic materials 6c, are temporarily placed on the rotating drum 83, and thus the height of the first vibrating feeder 2 is set to be the same as or slightly lower than the height of the rotating drum 83, but the height of the first vibrating feeder 2 may be set to be higher than the rotating drum 83 to make the waste scrap fall onto the rotating drum 83.

As described above, in the case of the drum-type magnetic separator in an overfeed mode, there is almost no need to provide a distance (clearance) between the tip of the first vibrating feeder 2 and the rotating drum 33. Therefore, just by adjusting the magnetic force of the electromagnet 82, the materials 6a for shredding such as thin and lightweight materials and the huge materials unsuitable for shredding 6b such as thick and heavyweight materials can be appropriately separated. When using the drum-type magnetic separator in a pick up mode, the adjustment of the clearance is required every time the size of typical waste scrap to be conveyed toward the drum-type magnetic separator varies. In contrast, in the case of the drum-type magnetic separator in an overfeed mode, the adjustment of the clearance is not required even when the size of typical waste scrap varies greatly, and thus the drum-type magnetic separator in an overfeed mode is particularly effective in such a case.

### Third Embodiment

In the first embodiment, it is assumed that when a material unsuitable for shredding is detected by the information processing device 10, the worker checks the screen illustrated in FIG. 7A or FIG. 7B and either directly removes the material unsuitable for shredding or operates the robot arm or the like to remove the material unsuitable for shredding. In this embodiment, there is explained an example where a hanging-type magnetic separator is provided over the second vibrating feeder 4 and the material unsuitable for shredding detected by the information processing device 10 is removed by magnetic force. In this embodiment, only the points that differ from the first embodiment are explained below.

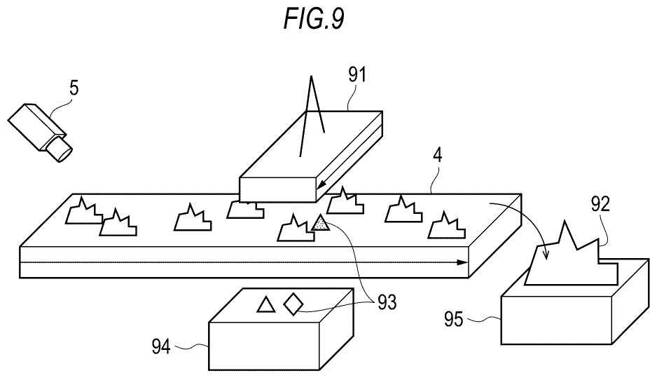

FIG. 9 is a view for explaining an outline of removing materials unsuitable for shredding that have been conveyed onto the second vibrating feeder 4 in this embodiment. As illustrated in FIG. 9, this embodiment is configured to further provide a hanging-type magnetic separator 91 as a removing device at the rear of the monitoring camera 5 in the system 100 for removing material unsuitable for shredding illustrated in FIG. 1.

The hanging-type magnetic separator 91 is installed over the second vibrating feeder 4, and its magnetic force is normally OFF when no material unsuitable for shredding is detected in the information processing device 10. Incidentally, the magnetic force of the hanging-type magnetic separator 91 can be switched ON and OFF by a not-illustrated control device. When the information processing device 10 detects a material unsuitable for shredding, information of that fact is input to the control device, and the magnetic force of the hanging-type magnetic separator 91 is switched ON. Specifically, when the information processing device 10 detects a material unsuitable for shredding, the result output unit 208 notifies the control device that controls the hanging-type magnetic separator 91 that a material unsuitable for shredding is included. At this time, the result output unit 208 notifies the control device of also the timing for turning the magnetic force ON, which is set in accordance with the timing at which the detected material unsuitable for shredding enters the range where the magnetic force of the hanging-type magnetic separator 91 is appropriately applied. For example, the result output unit 208 notifies the control device of also the timing for turning the magnetic force ON depending on the feeding speed of the second vibrating feeder 4 and the distance between the position on the second vibrating feeder 4 where the monitoring camera 5 photographs and the position just below the hanging-type magnetic separator 91. In the above, the case where the arithmetic calculation of the timing for turning the above-described magnetic force ON is performed in the result output unit 208 has been described, but the arithmetic calculation of the timing for turning the magnetic force ON may be performed in another device.

When receiving a notification from the information processing device 10 that a material unsuitable for shredding is included, the control device turns the magnetic force of the hanging-type magnetic separator 91 ON after a predetermined time, and a material unsuitable for shredding 93 being conveyed on the second vibrating feeder 4 is attracted to the hanging-type magnetic separator 91. As the hanging-type magnetic separator 91, for example, a well-known type as described in the microfilm of Japanese Utility Model Application No. 61-110324 (Japanese Unexamined Utility Model Application Publication No. 63-16850) can be applied.

A conveyor, which moves towards the direction of a box 94 that stores materials unsuitable for shredding (in a direction perpendicular to the second vibrating feeder 4), is provided on a lower surface of the hanging-type magnetic separator 91, and the material unsuitable for shredding 93 moves toward just above the box 94 that stores materials unsuitable for shredding while being attracted to the conveyor, and when the material unsuitable for shredding 93 reaches a position where the material unsuitable for shredding 93 can fall into the box 94, such as a position just above the box 94, the material unsuitable for shredding 93 falls into the box 94 that stores materials unsuitable for shredding because the magnetic force of the hanging-type magnetic separator 91 is no longer applied to that position. Then, after all the materials unsuitable for shredding have fallen, the control device turns the magnetic force of the hanging-type magnetic separator 91 back to OFF. Meanwhile, a material 92 for shredding, which is scheduled to be fed into the shredding facility, is, without being attracted to the hanging-type magnetic separator 91, conveyed accordingly on the second vibrating feeder 4 to the vicinity of the end, where it falls down and is collected in a box 95 that stores waste scrap. The magnetic force of the hanging-type magnetic separator 91 is adjusted in advance so that only the materials unsuitable for shredding can be attracted when the magnetic force of the hanging-type magnetic separator 91 is turned ON.

As described above, in this embodiment, even after a material unsuitable for shredding is detected, by switching the magnetic force ON and OFF at the hanging-type magnetic separator simply, waste scrap that can be fed into the shredding facility and the material unsuitable for shredding can be separated. Further, since the magnetic force of the hanging-type magnetic separator 91 is switched ON at the stage where a material unsuitable for shredding is detected, the display of such a screen as illustrated in FIG. 7A or FIG. 7B may be made unnecessary. That is, when a material unsuitable for shredding is detected, the destination to which the information indicating that a material unsuitable for shredding is included is output may not be the display device that generates a screen (for example, FIG. 7A or FIG. 7B) intended to encourage the worker to remove the material, but may be the removing device that automatically removes materials unsuitable for shredding. Furthermore, although the example where the material unsuitable for shredding 93 is collected into the box 94 and other waste scrap is collected into the box 95 has been explained in the above, the material unsuitable for shredding 93 may be collected into the box 95 and other waste scrap may be collected into the box 94 in a reverse manner. In this case, the ON/OFF timing of the hanging-type magnetic separator is also reversed. That is, the magnetic force is turned OFF only at a timing at which a material unsuitable for shredding is detected, and is ON at other times other than the above.

### Fourth Embodiment

In the first embodiment, the information on the volume or height of an individual piece of waste scrap is acquired based on the measurement result of the three-dimensional shape, and whether or not the candidate for material unsuitable for shredding is a material unsuitable for shredding that should be removed is determined. Meanwhile, for the waste scrap that may cause damage to the shredding facility, strictly speaking, the thickness rather than the height is important. Further, there is sometimes a case where the waste scrap being conveyed on the second vibrating feeder 4 is conveyed while being piled up, and in such a case, the thickness of an individual piece of piled waste scrap cannot be accurately measured only with the height of the waste scrap. Thus, in this embodiment, information on the thickness of an individual piece of waste scrap is also further acquired, enabling a material unsuitable for shredding to be more appropriately identified. In this embodiment, only the points that differ from the first embodiment are explained below.

The volume calculation unit 206 further calculates the thickness of an individual piece of waste scrap, based on the measurement result input from the three-dimensional shape measuring device 8 at Step S403. As in the first embodiment, calculation of the thickness of waste scrap, which does not clearly belong to the material unsuitable for shredding based on the measurement result of the three-dimensional shape, may be omitted. There is explained a specific procedure for calculating the thickness of an individual piece of waste scrap below.

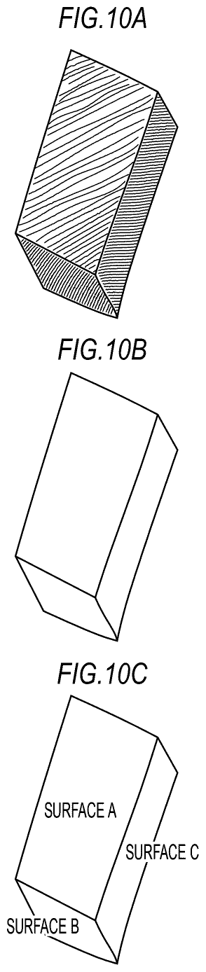

FIG. 10A is a view illustrating a specific example of basic shape data. The shape basic information is a two-dimensional image of a target object to be used to obtain three-dimensional shape information. The volume calculation unit 206 acquires a two-dimensional image of a target object as the shape basic information, for example, as illustrated in FIG. 10A. The two-dimensional image of the target object is, for example, a partial image obtained by filtering a part of a region including a target object from a photographed image acquired by the image acquisition unit 201. Such filtering may be, for example, processing of extracting a fixedly set region (for example, a region in which a target object is always seen), processing of extracting a region having specific color information (color information that the target object has), or processing of extracting a region having a specific shape, such as the shape of a typical material unsuitable for shredding.

Then, the volume calculation unit 206 performs, on the two-dimensional image, image processing of extracting edges (line segments corresponding to the outer shape of the target object), for example, to thereby generate an image of the target object illustrating edges. FIG. 10B is a view illustrating a specific example of an image in which edges extracted from the two-dimensional image in FIG. 10A are illustrated. Such processing of extracting edges may be performed by applying a high-pass filter to the two-dimensional image, for example.

Further, the volume calculation unit 206 performs, for example, on the two-dimensional image, image processing of extracting surfaces to thereby generate an image illustrating surfaces. FIG. 10C is a view illustrating a specific example of an image in which surfaces extracted from the two-dimensional image in FIG. 10A are illustrated. Such processing of extracting surfaces may be performed, for example, by detecting edges in the two-dimensional image, detecting regions surrounded by the edges, and labeling each of the detected regions (associating each detected region with identification information of each region). Each labeled region may be detected as a single surface.

Incidentally, when point cloud data that are information representing the shape of an individual piece of waste scrap are included as the measurement result of the three-dimensional shape measuring device 8, the surfaces of an individual piece of waste scrap may be identified from the point cloud data.

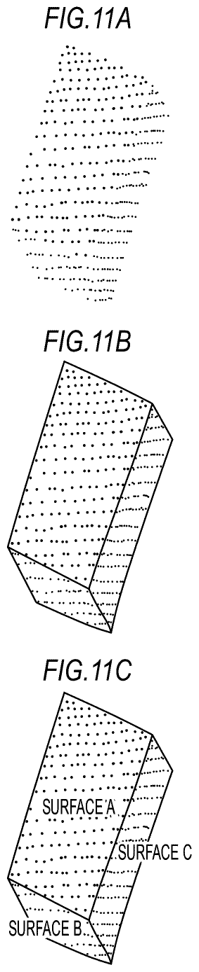

FIG. 11A is a view illustrating a specific example of the point cloud data. For example, when point cloud data of the target object are obtained from the three-dimensional shape measuring device 8 as illustrated in FIG. 11A, the volume calculation unit 206 performs processing of extracting edges on the point cloud data, for example, to thereby generate information illustrating the edges. FIG. 11B is a view illustrating a specific example of the edges extracted from the point cloud data in FIG. 11A. Such processing of extracting edges may be executed as follows. First, a normal vector is obtained based on the data of a predetermined number of points located in the neighborhood in the point cloud data. For example, based on the data of three neighboring points, a normal vector to the plane containing these three points may be obtained. Regions that are adjacent to each other and whose normal vector orientations are within a predetermined threshold value are determined as the same surface, and surfaces are determined for all point cloud data of the target object. Line segments that indicate the boundary where surfaces meet are extracted as edges. Such processing is merely an example of processing for acquiring edge-related information from shape information (for example, the point cloud data). The edge-related information may also be acquired from the point cloud data by another processing.

Furthermore, the volume calculation unit 206 performs processing of extracting surfaces on the point cloud data, for example, to thereby generate information that identifies the surfaces. FIG. 11C is a view illustrating a specific example of the surfaces extracted from the point cloud data in FIG. 11A. Regarding such processing of extracting surfaces, as described above, a normal vector may be obtained based on the data of a predetermined number of points located in the neighborhood in the point cloud data, and based on the normal vector, each surface may be extracted. By executing one or more of pieces of the processing explained above, the volume calculation unit 206 acquires the shape information related to edges and surfaces. Incidentally, the volume calculation unit 206 may acquire the shape information by a process different from the ones explained above.

Regarding the edges or surfaces extracted by the above-described processing, the volume calculation unit 206 may perform further processing to thereby acquire other shape information as well.

Once having acquired pieces of the edge and surface information as the shape information as above, the volume calculation unit 206 acquires information representing the lengths between parallel edges (line segments) for each surface, finds the minimum value of the plural lengths that appear within each rectangular parallelepiped (each individual piece), and sets this value as the thickness of an individual piece of waste scrap.

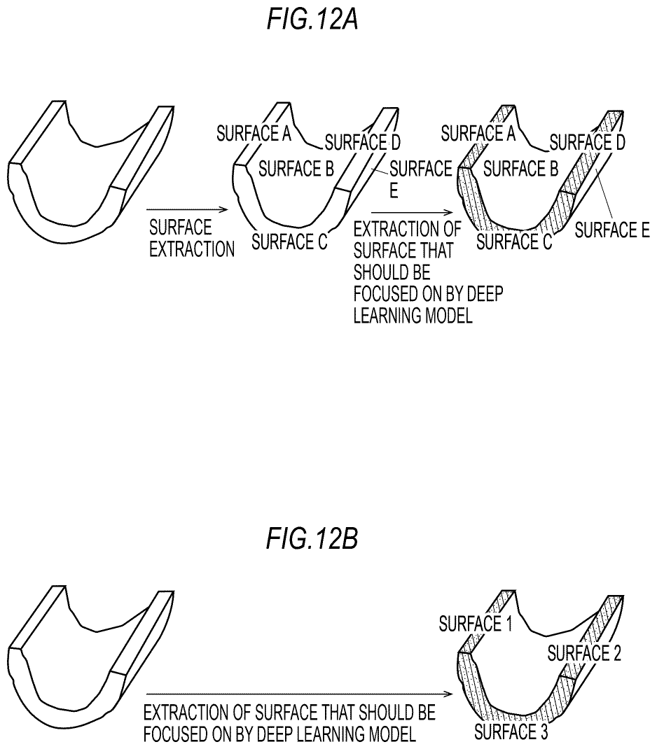

In the above-described procedure, the thickness of an individual piece of waste scrap is calculated on the assumption that the waste scrap is a rectangular parallelepiped, but there are pieces of waste scrap having various shapes, in which a piece having such a shape as a half-cut steel pipe, for example, is included, in some cases. In this case, it is not obvious which surface thickness should be focused on when determining the possibility of causing damage to the shredding facility. Therefore, after identifying the surfaces in the same manner as the procedure described above, the information may be further input into a deep learning model or the like, to thereby output the surfaces that should be focused on when finding the thickness of the waste scrap. In the case of the example in FIG. 12A, the volume calculation unit 206 first identifies surfaces A to E using a two-dimensional image or point cloud data. Then, the volume calculation unit 206 uses a deep learning model or the like to identify the surface A, the surface C, and the surface D (the shaded portions on the right side in FIG. 12) as surfaces that should be focused on. When using the deep learning model, the volume calculation unit 206 inputs all of the surfaces identified in the waste scrap into the deep learning model, and outputs, from among the surfaces, the surfaces that should be focused on when considering the possibility of causing damage to the shredding facility as identification results. Further, as in the example illustrated in FIG. 12B, the volume calculation unit 206 may be configured to receive the two-dimensional image or point cloud data to directly output the surfaces that should be focused on by another deep learning model. When using this deep learning model, the volume calculation unit 206 inputs the two-dimensional image or point cloud data of the waste scrap into the deep learning model, and outputs the surfaces that should be focused on when considering the possibility of causing damage to the shredding facility as identification results. Then, the volume calculation unit 206 acquires information indicating the lengths between parallel edges (line segments) of the surfaces that should be focused on in the same manner and sets, for example, the minimum value of the lengths as the thickness of the waste scrap.

After calculating the thickness of an individual piece of waste scrap as described above, at Step S404, the determination unit 207 determines, from the thickness information of an individual piece of Waste scrap, whether or not the candidate for material unsuitable for shredding is a material unsuitable for shredding that should be removed. For example, when plural pieces of waste scrap, which are in a piled-up state, are determined to be one object, the volume or height of the object is greater than that of each object, but as far as the thickness is concerned, it does not increase even if they are stacked. Thus, according to this embodiment, even in the case where waste scrap is conveyed while being piled up on the second vibrating feeder 4, the thickness information of an individual piece of waste scrap is acquired, making it possible to more appropriately identify a material unsuitable for shredding.

Further, when acquiring shape information of the waste scrap using the point cloud data illustrated in FIG. 11A, information on at least one of the volume, the height, and the thickness of the waste scrap can be acquired without using a photographed image. Therefore, when determining whether the candidate for material unsuitable for shredding is a material unsuitable for shredding that should be removed based only on the information on the volume, the height, or the thickness of an individual piece of waste scrap, the identification of the candidate for material unsuitable for shredding by the unsuitable material identification unit 202 may be omitted, and the material may be identified as a material unsuitable for shredding when its volume, height, or thickness is equal to or greater than a predetermined value. This eliminates the need for the monitoring camera 5, resulting in that the material unsuitable for shredding can be identified only from the measurement result of the three-dimensional shape measuring device 8. Further, it is also possible to install a plurality of the three-dimensional shape measuring devices and integrate the measurement results of these devices to more accurately acquire thickness information of a material unsuitable for shredding.

### Other Embodiment

Incidentally, the information processing device in each of the above-described embodiments is specifically configured by a computer system or device. Therefore, it goes without saying that the object of the present invention can be achieved by supplying a storage medium storing a program code of software that implements the previously-described functions to the system or device, and having the computer (or CPU or MPU) of the system or device read and execute the program code stored in the storage medium.

In this case, the program code itself read from the storage medium implements the functions of the previously-described embodiment and the program code itself and the storage medium storing the program code configure the present invention. As the storage medium for supplying the program code, for example, flexible disks, hard disks, optical disks, magneto-optical disks, CD-ROMs, CD-Rs, magnetic tapes, non-volatile memory cards, ROMs, and so on can be used.

It should be noted that the embodiments explained above merely illustrate concrete examples of implementing the present invention, and the technical scope of the present invention is not to be construed in a restrictive manner by these embodiments. That is, the present invention may be implemented in various forms without departing from the technical spirit or main features thereof.

Specifically, in the system 100 for removing material unsuitable for shredding illustrated in FIG. 1, materials unsuitable for shredding are removed via the pre-shredder 1, the first vibrating feeder 2, the drum-type magnetic separator 3, the second vibrating feeder 4, and the monitoring camera 5 (and the three-dimensional shape measuring device 8), but the system 100 for removing material unsuitable for shredding may omit some of these. For example, when there is no large-sized waste scrap, the pre-shredder 1 may be omitted. Further, in the previously-described first embodiment, the three-dimensional shape measuring device 8 may also be omitted.

Furthermore, in the example in FIG. 1, the system 100 for removing material unsuitable for shredding includes the drum-type magnetic separator 3 and the monitoring camera 5 (and the information processing device 10) for identifying and discharging materials unsuitable for shredding, but either one of them may be omitted. As an example, the system 100 for removing material unsuitable for shredding may be configured only with the drum-type magnetic separator 3, or may also be configured only with the first vibrating feeder 2 and the drum-type magnetic separator 3. In this case, the first vibrating feeder 2 may be replaced with a general non-vibrating belt conveyor, or may also be replaced with a combination of the first vibrating feeder 2 and a general non-vibrating belt conveyor. Further, when the drum-type magnetic separator 3 is omitted, the system 100 for removing material unsuitable for shredding may be configured only with the second vibrating feeder 4 and the monitoring camera 5 (and the information processing device 10). In this case, the second vibrating feeder 4 may be replaced with a general non-vibrating belt conveyor, or may also be replaced with a combination of the second vibrating feeder 4 and a general non-vibrating belt conveyor. On the other hand, when both the drum-type magnetic separator 3 and the monitoring camera 5 are provided, the order may be reversed. That is, after identifying materials unsuitable for shredding by the monitoring camera 5 (and the information processing device 10) and removing them, magnetic materials having a weight equal to or greater than a predetermined weight, which were not able to be identified as material unsuitable for shredding, may be removed by the drum-type magnetic separator 3. Further, in each of the configurations described above, the monitoring camera 5 may be replaced with the three-dimensional shape measuring device 8, or may also be replaced with a combination of the monitoring camera 5 and the three-dimensional shape measuring device 8. Further, two or more of the previously-described embodiments may be combined as appropriate, for example, by combining the first, third, and fourth embodiments, or by combining the second to fourth embodiments.

### INDUSTRIAL APPLICABILITY

According to the present invention, before feeding waste scrap into a shredding facility, materials unsuitable for shredding that may damage the shredding facility can be accurately removed from individual pieces of waste scrap, and this has great industrial value.

1. A system for removing material unsuitable for shredding that removes, before feeding scrap into a shredding facility that shreds the scrap, materials unsuitable for shredding that may cause damage to the shredding facility, the system comprising:
a drum-type magnetic separator whose magnetic force is set so as to attract a magnetic material having a weight less than a predetermined weight from the scrap; and
an information processing device including: an identification means configured to identify a magnetic material that is to be the material unsuitable for shredding, based on at least one of a photographed image and a measurement result of a three-dimensional shape of a magnetic material having been attracted to and separated by the drum-type magnetic separator; and an output means configured to output, when a material unsuitable for shredding is identified by the identification means, information indicating that the material unsuitable for shredding is included.

2. The system for removing material unsuitable for shredding according to claim 1, further comprising:
an imaging device that photographs a magnetic material having been attracted to and separated by the drum-type magnetic separator, wherein
the information processing device further includes:
an acquisition means configured to acquire the photographed image from the imaging device, and
the identification means uses a learning model that identifies the material unsuitable for shredding to identify the material unsuitable for shredding from a photographed image acquired by the acquisition means.

3. The system for removing material unsuitable for shredding according to claim 1, further comprising:
a three-dimensional shape measuring device that measures a three-dimensional shape of a magnetic material having been attracted to and separated by the drum-type magnetic separator, wherein
the information processing device further includes:
a means to acquire measurement result, where the means is configured to acquire information on at least one of a volume, a height, and a thickness of the magnetic material as a measurement result of a three-dimensional shape of the magnetic material, and
the identification means identifies a material unsuitable for shredding from magnetic materials having been attracted to and separated by the drum-type magnetic separator, based on information acquired by the means to acquire measurement result.

4. The system for removing material unsuitable for shredding according to claim 1, further comprising:
a first vibrating feeder that conveys scrap that has been coarsely shredded by a pre-shredder, wherein
the drum-type magnetic separator attracts a magnetic material having a weight less than a predetermined weight from the scrap conveyed by the first vibrating feeder.

5. The system for removing material unsuitable for shredding according to claim 4, wherein
the drum-type magnetic separator is configured to enable at least one of a distance from the first vibrating feeder, a magnetic force of an electromagnet of a drum, and a rotation speed of the drum to be adjusted.

6. The system for removing material unsuitable for shredding according to claim 2, further comprising:
a second vibrating feeder that conveys magnetic materials having been attracted to and separated by the drum-type magnetic separator, wherein
the imaging device photographs a magnetic material on the second vibrating feeder or on a conveyor downstream of the second vibrating feeder.

7. The system for removing material unsuitable for shredding according to claim 1, further comprising:
a removing device that removes, when the output means outputs information indicating that the material unsuitable for shredding is included, the material unsuitable for shredding.

8. The system for removing material unsuitable for shredding according to claim 3, wherein
the means to acquire measurement result acquires information on at least the thickness of the magnetic material as a measurement result of a three-dimensional shape of the magnetic material.

9. A drum-type magnetic separator that configures a system for removing material unsuitable for shredding that removes, before feeding scrap into a shredding facility that shreds the scrap, materials unsuitable for shredding that may cause damage to the shredding facility, wherein
a magnetic force is set so as to attract a magnetic material having a weight less than a predetermined weight from the scrap.

10. The drum-type magnetic separator according to claim 9, wherein
the drum-type magnetic separator is configured to enable at least one of a distance from a vibrating feeder that conveys the scrap, a magnetic force of an electromagnet of a drum, and a rotation speed of the drum to be adjusted.

11. The drum-type magnetic separator according to claim 9, wherein
the scrap includes scrap that has been coarsely shredded by a pre-shredder.

12. An information processing device that acquires at least one of a photographed image and a measurement result of a three-dimensional shape of a magnetic material in a system for removing material unsuitable for shredding that removes, before feeding scrap into a shredding facility that shreds the scrap, materials unsuitable for shredding that may cause damage to the shredding facility, the information processing device comprising:
an identification means configured to identify a magnetic material that is to be the material unsuitable for shredding, based on at least one of a photographed image and a measurement result of a three-dimensional shape of the magnetic material; and
an output means configured to output, when a material unsuitable for shredding is identified by the identification means, information indicating that the material unsuitable for shredding is included.

13. The information processing device according to claim 12, further comprising:
an acquisition means configured to acquire the photographed image from an imaging device, wherein
the identification means uses a learning model that identifies the material unsuitable for shredding to identify the material unsuitable for shredding from a photographed image acquired by the acquisition means.

14. The information processing device according to claim 12, further comprising:
a means to acquire measurement result, where the means is configured to acquire information on at least one of a volume, a height, and a thickness of the magnetic material as a measurement result of a three-dimensional shape of the magnetic material, wherein
the identification means identifies a material unsuitable for shredding from the magnetic material, based on information acquired by the means to acquire measurement result.

15. The information processing device according to claim 13, wherein
the acquisition means acquires, from the imaging device, a photographed image of a magnetic material being conveyed by a vibrating feeder or by a conveyor downstream of a vibrating feeder.

16. The information processing device according to claim 14, wherein
the means to acquire measurement result acquires information on at least the thickness of the magnetic material as a measurement result of a three-dimensional shape of the magnetic material.

17. The information processing device according to claim 12, wherein
the magnetic material includes magnetic materials that have been coarsely shredded by a pre-shredder.

18-21. (canceled)
